(19) United States
(12) Patent Application Publication
(10) Pub. No.: US 2021/0023729 A1
(43) Pub. Date: Jan. 28, 2021

(54) HAIR REMOVAL APPARATUS, ASSEMBLY, AND METHOD FOR ASSEMBLING THE SAME

(71) Applicant: Church & Dwight Co., Inc., Princeton, NJ (US)

(72) Inventors: Eric Langberg, Milford, PA (US); Aaron Szymanski, Thomaston, CT (US)

(73) Assignee: Church & Dwight Co., Inc., Princeton, NJ (US)

(21) Appl. No.: 16/935,879

(22) Filed: Jul. 22, 2020

Related U.S. Application Data
(60) Provisional application No. 62/877,124, filed on Jul. 22, 2019.
(60) Provisional application No. 62/923,374, filed on Oct. 18, 2019.

(51) Int. Cl. B26B 19/38; B26B 19/04; B26B 19/46; F21V 23/04; F21V 33/00

(52) U.S. Cl. CPC B26B 19/386; B26B 19/04; B26B 19/3873; F21V 33/004; B26B 19/3886; F21V 23/04; B26B 19/46

(57) ABSTRACT

A hair removal apparatus is disclosed, where the apparatus includes a curved shell having an outer surface and defining an internal cavity extending along a length of the curved shell from an open rear end to an open front end of the shell; a core frame structure defining a first end and an opposing second end, and including a transmission arranged toward the first end of the core frame structure, a charging receptacle, and a motor arranged between the transmission and the charging receptacle and coupled to the transmission, wherein the shell is configured to receive the core frame structure through the open rear end thereof so that the core frame structure is positioned in the internal cavity of the shell such that the transmission is arranged near the open front end of the shell; and a blade assembly engageable with the open front end of the shell.

### CROSS-REFERENCE TO RELATED APPLICATIONS

This application claims priority to U.S. Provisional Application No. 62/923,374, filed Oct. 18, 2019, and entitled, “HAIR REMOVAL APPARATUS,” and claims priority to U.S. Provisional Application No. 62/877,124, filed Jul. 22, 2019, and entitled, “HAIR REMOVAL APPARATUS,” each of these applications being incorporated herein by reference in their entirety.

### FIELD OF THE DISCLOSURE

The present disclosure relates to a hair removal apparatus, and in particular to a hair removal apparatus, assembly, and method for assembling the same where the hair removal apparatus includes a core frame structure inserted into a shell and a blade assembly engaged with the shell.

### BACKGROUND

Hair removal products, such as razors, can generally be categorized as either a manual or an electric type product. Electric hair removal products (e.g., electric razors) often can be used without any type of lubricant on the epidermis or the outer layer of skin, while manual hair removal products (e.g., wet razors) are typically used with a lubricant.

A wet shaving razor is usually disposable after a certain number of uses or has a replaceable cartridge in which one or more blades are mounted in a blade assembly. After the blades in a cartridge have become dull from use, the cartridge is discarded, and a new cartridge is engaged with the handle. In use, the blades of a wet shaving razor come into direct contact with the epidermis and may result in nicks, cuts, or other wounds that may become infected. The likelihood of this happening is increased when dull blade(s) are used. Thus, it is important to dispose of disposable razors or replace the cartridge on wet shaving razors on a weekly or biweekly basis. However, purchasing new disposable razors and replaceable cartridges at such a rate is expensive, so often users wait longer than advised to do so.

Advantageously, electric razors typically have at least one moving blade and a stationary blade that is in direct contact with the skin, where the stationary blade acts as a guard so that the moving blade does not come into direct contact with the epidermis when in use. This helps to reduce the number of nicks and cuts that a user of a wet shaving razor may experience. However, since electric razors require power sources to reciprocate the moving blade, it is generally recommended to store electric razors away from water sources (e.g., sinks, showers, or baths) in order to prevent any water damage to the circuitry of the electric razor. This is often inconvenient as razors are typically stored near water sources such as sinks, showers, or baths for ease of use.

Accordingly, there exists a need for a hair removal apparatus, assembly, and method for assembling the same that addresses or solves at least the issues mentioned herein.

### BRIEF SUMMARY OF THE DISCLOSURE

In one embodiment, the present invention relates to a hair removal apparatus, assembly, and method for assembling the same. In some example embodiments, a hair removal apparatus is disclosed, the hair removal apparatus comprising: a curved shell having an outer surface and defining an internal cavity extending along a length of the curved shell from an open rear end to an open front end of the shell; a core frame structure defining a first end and an opposing second end, and comprising: a transmission arranged toward the first end of the core frame structure, a charging receptacle arranged toward the second end of the core frame structure, and a motor arranged between the transmission and the charging receptacle and coupled to the transmission, wherein the shell is configured to receive the core frame structure through the open rear end thereof so that the core frame structure is positioned in the internal cavity of the shell such that the transmission is arranged near the open front end of the shell; and a blade assembly engageable with the open front end of the shell and comprising a moving blade, the transmission being coupled to the moving blade so that upon actuation of the motor, the moving blade reciprocates.

The hair removal apparatus of any subsequent or preceding embodiment, or any combination of subsequent and preceding embodiments, wherein the core frame structure further comprises a power source arranged between the motor and the charging receptacle, the power source being electrically-connected to the motor and the charging receptacle.

The hair removal apparatus of any subsequent or preceding embodiment, or any combination of subsequent and preceding embodiments, wherein the core frame structure further comprises an actuator arranged toward the first end of the core frame structure, wherein force applied to the actuator alters an operating condition of the hair removal apparatus and causes electrical current to flow from the power source to the motor so as to actuate the motor and cause the moving blade to reciprocate in a first operating condition, and causes the electrical current to cease to flow in a second operating condition.

The hair removal apparatus of any subsequent or preceding embodiment, or any combination of subsequent and preceding embodiments, further comprising a first light source electrically-connected with the power source, wherein in response to the application of force applied to the actuator, the first light source provides illumination when the electrical current flows from the power source to the first light source in the first operating condition.

The hair removal apparatus of any subsequent or preceding embodiment, or any combination of subsequent and preceding embodiments, further comprising an angled lighting cavity formed between an angled surface of the core frame structure and the shell, the lighting cavity having a substantially transparent window arranged on the outer surface of the shell so as to direct the illumination along the angled surface of the core frame structure and through the substantially transparent window toward the blade assembly.

The hair removal apparatus of any subsequent or preceding embodiment, or any combination of subsequent and preceding embodiments, wherein a reflective coating is applied to the angled surface of the core frame structure to reflect the illumination from the angled surface of the core frame structure toward the blade assembly.

The hair removal apparatus of any subsequent or preceding embodiment, or any combination of subsequent and preceding embodiments, wherein the core frame structure further comprises a power switch coupled to the actuator, the power switch controlling the flow of the electrical current from the power source to the motor in response to the application of force to the actuator.

The hair removal apparatus of any subsequent or preceding embodiment, or any combination of subsequent and preceding embodiments, wherein the actuator is hinged such that the application of force to the actuator causes the actuator to hingedly rotate about a hinged axis of the hinge and depress the power switch so as to control the flow of the electrical current from the power source to the motor.

The hair removal apparatus of any subsequent or preceding embodiment, or any combination of subsequent and preceding embodiments, further comprising a second light source electrically-connected with the power source, wherein a portion of the shell aligned with the actuator defines a substantially translucent region that allows, in response to the application of force to the actuator, illumination from the second light source to illuminate the translucent region from the internal cavity so that the illumination is visible through the outer surface of the shell and provides an indication of the hair removal apparatus being powered on in the first operating condition.

The hair removal apparatus of any subsequent or preceding embodiment, or any combination of subsequent and preceding embodiments, wherein the illumination of the second light source is intermittent during charging of the power source through the charging receptacle.

The hair removal apparatus of any subsequent or preceding embodiment, or any combination of subsequent and preceding embodiments, wherein the portion of the shell aligned with the actuator includes a portion of the first layer that defines an opening, and wherein the substantially translucent region is a portion of the second layer that is substantially translucent such that the illumination from the second light source illuminates the translucent region of the second layer from the internal cavity and through the opening in the first layer so that the illumination is visible through the outer surface of the shell and provides an indication of the hair removal apparatus being powered on.

The hair removal apparatus of any subsequent or preceding embodiment, or any combination of subsequent and preceding embodiments, wherein the curved shell comprises at least a first rigid layer formed as a one-piece construction.

The hair removal apparatus of any subsequent or preceding embodiment, or any combination of subsequent and preceding embodiments, wherein the curved shell comprises at least a second resilient layer and the second resilient layer is attached to the first rigid layer formed as the one-piece construction so as to provide the curved outer shell with a substantially continuous outer surface.

The hair removal apparatus of any subsequent or preceding embodiment, or any combination of subsequent and preceding embodiments, wherein the open rear end of the shell is angled away from a longitudinal axis of the shell extending along the length thereof and the second end of the core frame structure is correspondingly angled away from a longitudinal axis of the core frame structure extending along a length thereof.

The hair removal apparatus of any subsequent or preceding embodiment, or any combination of subsequent and preceding embodiments, further comprising a rear cover engageable with the open rear end of the shell so as to cover and form a seal over the open rear end of the shell, wherein the rear cover defines an aperture, at least a portion of the charging receptacle extending out of the shell and into the aperture of the rear cover when the rear cover is engaged with the open rear end of the shell.

The hair removal apparatus of any subsequent or preceding embodiment, or any combination of subsequent and preceding embodiments, further comprising a transmission arm comprising a mechanical coupling for mechanically coupling the transmission arm with the transmission, wherein the transmission arm extends through the open front end of the shell for coupling with the blade assembly, and wherein the mechanical coupling between the transmission and the transmission arm causes the transmission arm to laterally reciprocate in response to actuation of the motor and thereby to cause lateral reciprocation of the moving blade relative to the length of the shell when the blade assembly is engaged with the open front end of the shell.

The hair removal apparatus of any subsequent or preceding embodiment, or any combination of subsequent and preceding embodiments, wherein the blade assembly further comprises: a blade housing arranged to retain the moving blade; a transmission arm receiver coupled to the moving blade and defining parallel side walls for receiving the transmission arm therein; and a connector frame hingedly coupled to the blade housing so that the blade housing is hingedly moveable relative thereto, the connector frame defining a channel aligned with the transmission arm receiver and arranged to receive the transmission arm therethrough when the channel is inserted into the open front end of the shell to engage the blade assembly with the open front end of the shell, wherein, upon engagement of the blade assembly with the shell, the transmission arm extends through the channel of the connector frame and laterally reciprocates against the parallel side walls of the transmission arm receiver to cause lateral reciprocation of the moving blade in response to actuation of the motor.

The hair removal apparatus of any subsequent or preceding embodiment, or any combination of subsequent and preceding embodiments, wherein the channel defines notches on opposing parallel sides of the channel, the notches of the sides of the channel being received by a resilient prong structure arranged about the open front end of the shell so as to engage the blade assembly with the shell.

The hair removal apparatus of any subsequent or preceding embodiment, or any combination of subsequent and preceding embodiments, wherein the outer surface of the shell comprises an ejection structure for disengaging the blade assembly from the open front end of the shell.

The hair removal apparatus of any subsequent or preceding embodiment, or any combination of subsequent and preceding embodiments, wherein the internal cavity comprises a middle portion between the first end and the second end, the middle portion comprising parallel upper and lower surfaces.

In another example embodiment, a hair removal assembly comprises: a shell comprising at least a first rigid layer coupled to a second resilient layer being attached to one another to form a handle, the handle having a curvature forming a grip, and comprising front and rear ends each having an opening, and a generally-linear internal cavity extending between the openings in the front and rear ends, the handle having a curvature forming a grip, the curvature extending between the front and rear ends; a core frame structure comprising a power source compartment with a first circuit board, the first circuit board is in electrical connection with a motor, the motor is coupled to a transmission and the transmission is coupled to a transmission arm, the core frame structure has a corresponding generally-linear shape designed to fit within the generally linear internal cavity of the shell by inserting the core frame structure into the open rear end of the shell so that the transmission arm extends through the open front end of the shell, the second resilient layer is designed to create a waterproof tight seal to protect the core frame structure; and a blade assembly comprising a blade housing, a moving blade and a stationary blade, the transmission arm is designed to engage the moving blade.

In a further example embodiment, a method for assembling a hair removal apparatus comprises: providing a shell comprising at least a curved, first rigid layer with front and rear ends each having an opening, the shell defining a generally-linear internal cavity extending between the openings; inserting a generally-linear shaped core frame structure into the open rear end of the shell and through the generally-linear internal cavity of the shell, the core frame structure comprising at least a circuit board, a motor, and a transmission coupled to a transmission arm, wherein the inserting causes the transmission arm to extend through the open front end of the shell; and engaging a blade assembly with the front end of the shell, the blade assembly comprising at least a blade housing, a moving blade, and a stationary blade, wherein the engaging causes the transmission arm to couple to the moving blade.

The method of any subsequent or preceding embodiment, or any combination of subsequent and preceding embodiments, further comprising attaching a second resilient layer of the shell to the curved first rigid layer to form a handle, the handle having a curvature forming a grip.

These and other features, aspects, and advantages of the disclosure will be apparent from a reading of the following detailed description together with the accompanying drawings, which are briefly described below. The invention includes any combination of two, three, four, or more of the above-noted embodiments as well as combinations of any two, three, four, or more features or elements set forth in this disclosure, regardless of whether such features or elements are expressly combined in a specific embodiment description herein. This disclosure is intended to be read holistically such that any separable features or elements of the disclosed invention, in any of its various aspects and embodiments, should be viewed as intended to be combinable unless the context clearly dictates otherwise.

### BRIEF DESCRIPTION OF THE DRAWINGS

Having thus described the disclosure in general terms, reference will now be made to the accompanying drawings, which are not necessarily drawn to scale, and wherein:

FIG. 1 is a cross-section view of the hair removal apparatus according to example implementations of the present disclosure.

FIG. 2 is a top view of the hair removal apparatus of FIG. 1.

FIG. 3 is a bottom view of the hair removal apparatus of FIG. 1.

FIG. 4 is an exploded side view of assembly of a shell and a core frame structure of the hair removal apparatus of FIG. 1.

FIG. 5 is an exploded side view of assembly of a shell and a blade assembly of the hair removal apparatus of FIG. 1.

FIG. 6 is a rear view of the hair removal apparatus of FIG. 1.

FIG. 7 is a view of an internal structure of a blade assembly of FIG. 1.

FIG. 8 is a view of a blade assembly of the hair removal apparatus of FIG. 1.

FIG. 9A is a perspective view of a charging unit for a hair removal apparatus according to example implementations of the present disclosure.

FIGS. 9B-9K are different perspective views of a rear cover and a charging receptacle for a hair removal apparatus according to example implementations of the present disclosure.

FIGS. 10A-10H are different views of a front portion of a core frame structure according to example implementations of the present disclosure.

FIGS. 11A-11E are various views of an angled lighting cavity according to example implementations of the present disclosure.

FIG. 12 is a top view of a transparent portion of a shell of a hair removal apparatus according to example implementations of the present disclosure.

FIG. 13A-14E are various views of example blade assemblies for a hair removal apparatus according to example implementations of the present disclosure.

FIG. 15A-15D are various views of assembly of a blade assembly to a handle according to example implementations of the present disclosure.

FIG. 16 is a method flow diagram of a method for assembling a hair removal apparatus according to example implementations of the present disclosure.

### DETAILED DESCRIPTION OF THE INVENTION

The present disclosure will now be described more fully hereinafter with reference to exemplary embodiments thereof. These exemplary embodiments are described so that this disclosure will be thorough and complete, and will fully convey the scope of the disclosure to those skilled in the art. Indeed, the disclosure may be embodied in many different forms and should not be construed as limited to the embodiments set forth herein; rather, these embodiments are provided so that this disclosure will satisfy applicable legal requirements. As used in the specification, and in the appended claims, the singular forms “a”, “an”, “the”, include plural variations unless the context clearly dictates otherwise.

A hair removal apparatus, assembly, and a method for assembling the same as disclosed herein relate to any type of hair removal apparatus having at least one blade, such as, but not limited to, a razor, a dermaplaning device, a trimmer, and the like. For example, a hair removal apparatus according to some embodiments may comprise a shell comprising at least two layers, a first rigid layer and a second resilient layer being attached or coupled to one another to form a handle. The shell may comprise a generally linear internal cavity, and front and rear ends, each end having an opening. The hair removal apparatus may comprise a core frame structure comprising front, middle and rear sections, where the core frame structure has a corresponding generally linear shape designed to fit within the generally linear internal cavity of the shell by inserting the core frame structure into the open rear end of the shell and allowing a portion of the front section to protrude from the open front end of the shell. The hair removal apparatus may also comprise a blade assembly comprising a blade housing, a moving blade and a stationary blade, the portion of the front section of the core frame structure is designed to engage and move the moving blade.

Thus, a hair removal apparatus as described herein may be advantageous in that the construction of the shell, where a resilient layer of the shell acts as a seal around electric components of a core frame structure that is inserted into the shell, results in the hair removal apparatus being substantially waterproof or water resistant, so that the hair removal apparatus may be used and/or stored near water. This resilient layer also aids with providing a grip for a user to grasp during use. Additionally, the hair removal apparatus as described herein may be rechargeable via a charging unit, have a removable and replaceable blade assembly, may be used dry to reduce water usage, and may include a hinged blade assembly to allow for the most ergonomic angle of use. These advantages, and more, are described more fully as follows.

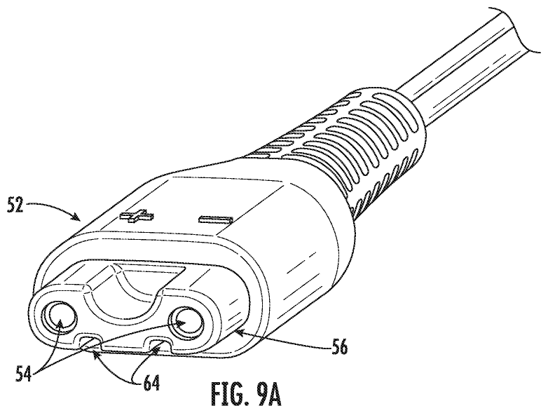

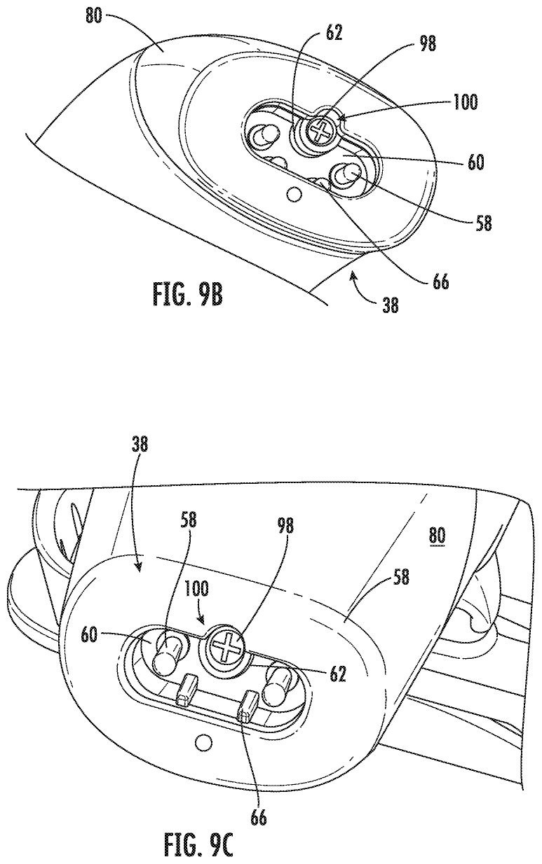

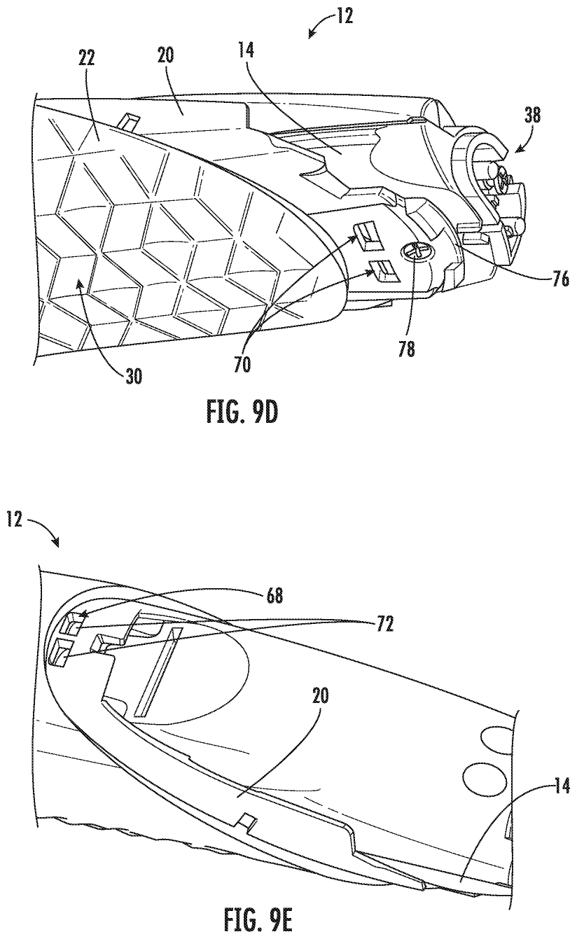

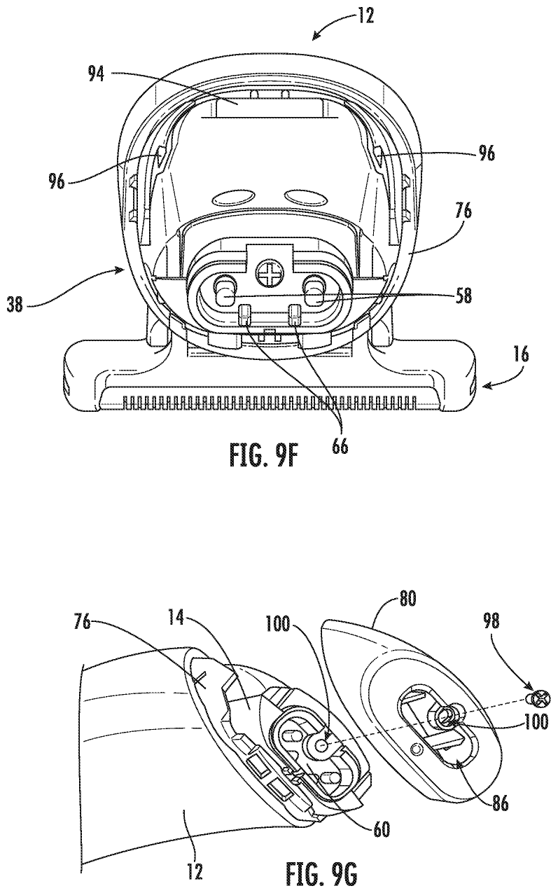

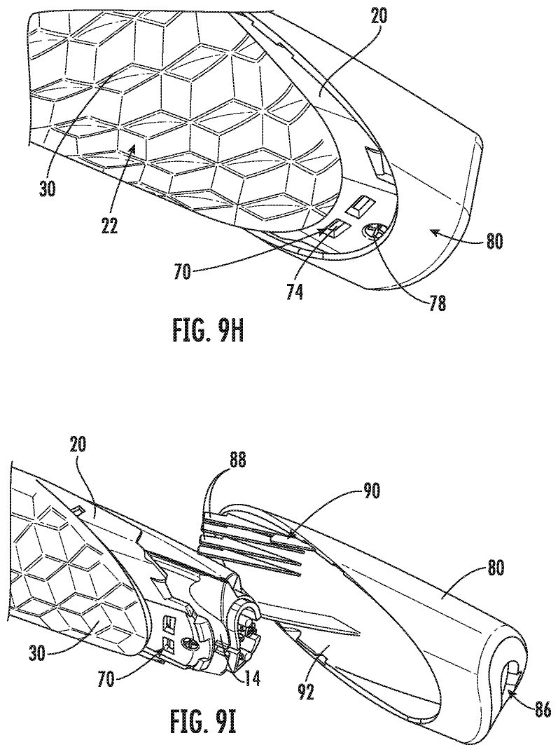

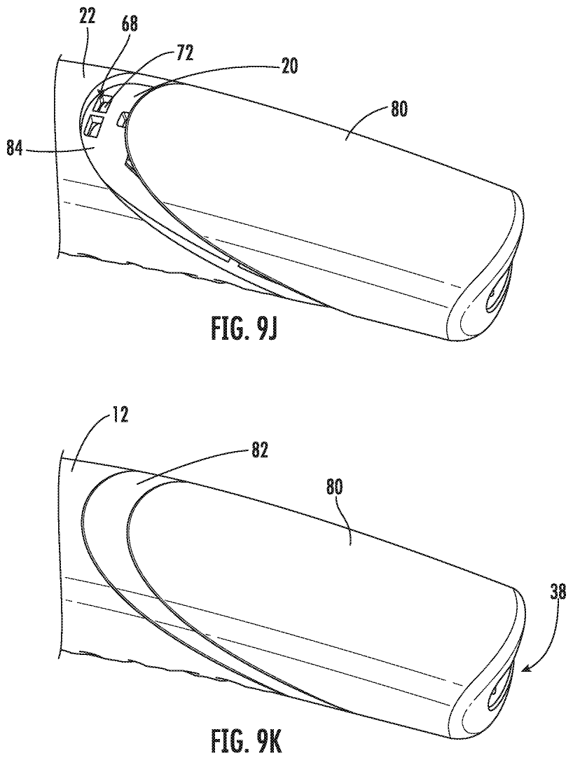

FIGS. 1-8 illustrate one example of a hair removal apparatus and assembly of that hair removal apparatus 10. As contemplated herein, the hair removal apparatus 10 comprises three main elements: a shell 12, a core frame structure 14, and a blade assembly 16. The shell 12 and the core frame structure 14 interact and form a handle 18 for a user to grip during use. Detailed views of the elements of each of the shell 12, the core frame structure 14, and the blade assembly 16 are provided in FIGS. 9A-15D and described below.

Referring first to the shell 12 as shown in FIG. 1, one or more layers may be attached or coupled to one another to form the shell 12. For example, the shell 12 may have a first layer 20 and a second layer 22. More layers are also contemplated, such as a third layer, fourth layer, fifth layer, etc. The first layer 20 may be considered a rigid layer that is inflexible and resistant to being bent or forced out of shaped so as to provide support to the hair removal apparatus 10. The first layer 20 may be formed of a polymeric material such as plastic, which may be formed from a renewable material such as corn or cellulose. The first layer 20 may be formed by three-dimensional (3D) printing, machining, casting, molding, vacuum forming, or any similar type of manufacturing method that yields the desired shape of the first layer 20. In some example embodiments, the first layer 20 along with the second layer 22 (and thereby the shell 12 and the handle 18) may be curved or have an arc-shape along a length of the shell 12, the length of the shell 12 being defined by a longitudinal axis A extending along the X-axis, from an open rear end 24 to an open front end 26. For example, the curvature of the first layer 20 may be formed from the open front end 26 and the open rear end 24 being curved downward in a Y-direction, away from the X-axis, so that an apex of the curve is around a middle of the shell 12, so that the curvature forming a grip extends between the open front and rear ends 24, 26. The curvature of the first layer 20 may also be formed from the open rear end 24 being wider in a Z-direction. As such, the curvature of the first layer 20 and the second layer 22 may result in the shell 12 and the handle 18 being considered “curved” along the X-axis in the Y-direction and/or the Z-direction.

In some example embodiments, the first layer 20 is formed with a hollow interior that defines an internal cavity 28. The internal cavity 28 may extend along the length of the shell 12 from the open rear end 24 to the open front end 26 of the shell 12. In order to create a seal in the internal cavity 28, gaskets or another type of sealing mechanism may be provided at the open rear end 24 and the open front end 26. The internal cavity 28 may be considered generally linear, as a majority of the length of the internal cavity 28 is linear and not curved. For example, and as illustrated in FIG. 1, at least a middle portion 28a of the internal cavity 28 is linear along the X-axis and comprises parallel upper and lower surfaces, while a front portion 28b and a rear portion 28c are slightly curved downward in a Y-direction away from the X-axis.

The second layer 22 may be considered a resilient layer that is flexible and able to spring back into shape after being bent, stretched, and/or compressed. The second layer 22 may also be formed of a polymeric material such as plastic. However, the second layer 22 may be more flexible than the first layer 20 and therefore, more comfortable to a user when grasping the hair removal apparatus 10. The second layer 22 may be formed by 3D printing, molding, bonding, adhesives, binding agents, and combinations thereof, the second layer 22 onto the first layer 20. In this manner, the shape of the first layer 20 may determine the shape of the second layer 22.

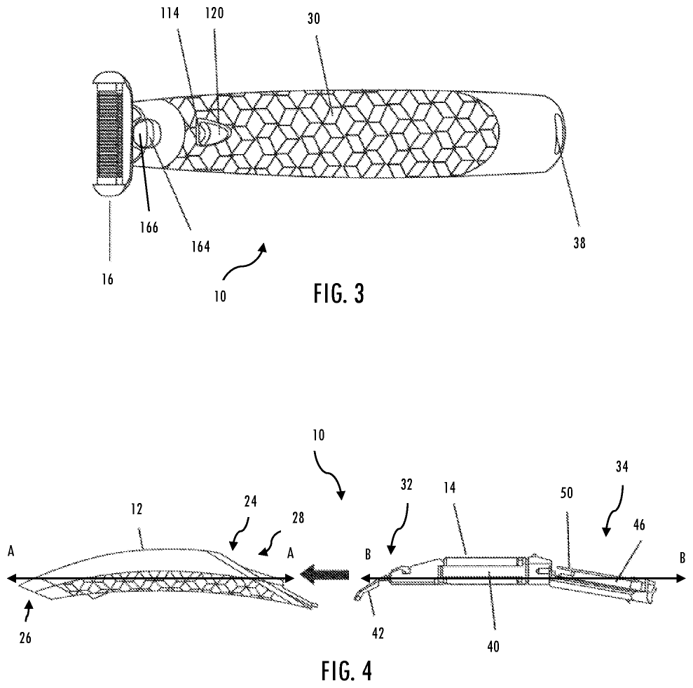

In some example embodiments, where the second layer 22 is the last layer used to form the shell 12, the second layer 22 may be considered as an outer surface of the shell. Thus, where the first layer 20 is curved as described herein, then with the attachment of the second layer 22 to the first layer 20, a curved handle 18 may be formed with a curved shell 12 having a curved outer surface. Further, where the second layer 22 is considered the outer surface of the shell 12, the handle 18 may have a curvature forming a grip for a user to grasp during use. In addition, the handle 18 may define a gripping surface 30 (FIG. 3) on a portion of the second layer 22. As illustrated in FIG. 3, for example, the gripping surface 30 may be formed as a textured portion of the second layer 22, or may otherwise be formed on or with the second layer 22 to provide a non-slip surface for a user to ergonomically grasp.

Accordingly, as described herein, the first layer 20 may be considered as being formed as a one-piece construction, where the first layer 20 is manufactured such that there is not more than one element forming the first layer 20 or, if more than one element forms the first layer 20, the elements are so engaged with one another (e.g., via ultrasonic welding) that the first layer 20 can be considered unitary or integral. More particularly, as is known in the art, it is often more cost-efficient to manufacture hair removal apparatuses with a structure having a top half and a bottom half (relative to the Y-direction) that attach to one another. When there is a top half and a bottom half a seam is formed at the attachment, which may be susceptible to infiltration of water and debris into the internal cavity 28. However, in order to enable a more substantially water resistant or waterproof hair removal apparatus, the present disclosure contemplates forming the first layer 20 so that there is not more than one element (or if more than one element forms the first layer 20, the elements are so engaged with one another they are considered unitary or integral) forming the first layer 20. When the second layer 22 is attached to the first layer 20 formed as a one-piece construction, as described herein, a curved outer shell 12 with a substantially continuous outer surface is formed from the second layer 22 creating a substantially waterproof tight seal with the first layer 20 so as to protect the core frame structure 14 and components within. More particularly, to be considered a “substantially continuous outer surface,” the second layer 22 covers a substantial entirety of the first layer 20 having a one-piece construction so that a substantial entirety of the second layer 22 (i.e., the outer surface) has no seams or is “seamless.” Without seams, the outer surface appears visually sleek and aesthetically appealing, and also prevents accumulation of debris in any seams and leakage of water into the internal cavity 28. As a result, the core frame structure 14 is insertable through the open rear end 24 and not sandwiched between two separate components of the first layer 20 as is typical in the art. However, a first layer 20 having a two-piece construction, three-piece construction, four-piece construction, etc., is contemplated by the disclosure herein, as well.

Referring now to the core frame structure 14, the core frame structure 14 may define a first end 32 and an opposing second end 34 with one or more mechanically and/or electrically interconnected elements that are securely positioned relative to one another. When the core frame structure 14 is inserted into the shell 12, in some example embodiments, the second layer 22 of the shell 12 may contact the core frame structure 12 and creates a seal.

In some example embodiments, the elements of the core frame structure 14 comprise a transmission 36 arranged toward the first end 32 of the core frame structure 14, a charging receptacle 38 arranged toward the second end 34 of the core frame structure 14, and a motor 40 arranged between the transmission 36 and the charging receptacle 38 and being coupled to the transmission 36. For example, the motor 40 is mechanically-connected to the transmission 36. The motor 40 may be a DC motor, such as, for example, a brushed DC motor, a brushless DC motor, a stepper motor, and the like. Alternatively, the motor 40 may be a brushless AC motor or a linear motor.

A transmission arm 42, which may comprise a separate or integral mechanical coupling 44 for mechanically coupling the transmission arm 42 with the transmission 36. The mechanical coupling 44 may be an end portion of the transmission arm 42 having parallel side walls that alternatingly come into contact with an offset pin of the rotating transmission 36 when the transmission 36 is actuated. Rotary motion of the motor 40 may be transmitted to the transmission 36, which may thereby be converted to reciprocating motion via the mechanical coupling 44. This conversion from the rotary motion of the motor 40 to lateral reciprocation of the transmission arm 42 is completed within the handle 18 as a result of the structure of the mechanical coupling 44. The lateral reciprocation of the mechanical coupling 44 thereby causes the transmission arm 42 to laterally reciprocate in response to actuation of the motor 40.

A power source 46 may be arranged between the motor 40 and the charging receptacle 38. The power source 46 may be a rechargeable battery securely positioned in a power source compartment 48 formed by the core frame structure 14 and arranged toward the second end 34 of the core frame structure 14. The power source 46 may be a power storage component that is electrically-connected to the motor 40 directly or via a first circuit board 50 that may also be housed in or adjacent to the power source compartment 48. The power source 46 may be electrically connected to the charging receptacle 38 directly or via the first circuit board 50.

Referring now to FIGS. 9A-9K, the charging receptacle 38 may comprise a charging port arranged toward the second end 34 of the core frame structure 14 that is formed to receive a charging unit 52 (FIG. 9A) with a mating male or female plug. As shown in FIG. 9A, female electrical contacts 54 formed on an outwardly extending portion 56 of the charging unit 52 may align with male charging pins 58 (FIGS. 9B and 9C) extending from a planar surface 60 on the charging receptacle 38, where the planar surface 60 forms the second end 34 of the core frame structure 14. The planar surface 60 may include an arc 62, so that the planar surface 60 is not fully oval-shaped. The male charging pins 58 may form an industry standard connector (e.g., a USB connector, a coaxial barrel connector, a lightning connector, etc.), or may be custom-formed in a specific arrangement. Otherwise, the charging port may be arranged to receive a USB-A, USB-B, mini-USB, micro-USB, USB 3, a FIG. 8 connector, etc., or may be integral with the charging unit 52. Alignment of the charging receptacle 38 and the charging unit 52 may be accomplished through alignment of notches 64 defined in the outwardly extending portion 56 of the charging unit and ribs 66 extending from the planar surface 60. Notably, the alignment of the notches 64 and the ribs 66, along with the arc 62, form a keying system such that the charging unit 52 may only be inserted into the charging receptacle 38 in a single orientation. Further, the keying system prevents the female electrical contacts 54 of the charging unit 52 from making physical contact with the male charging pins 58 of the charging receptacle 38 if insertion of the charging unit 52 is attempted while the charging unit 52 is accidentally reversed. However, the charging unit 52 and the charging receptacle 38 may be constructed so that the charging unit 52 may be able to be inserted into the charging receptacle 38 in any orientation.

Alternatively, the charging receptacle 38 may comprise charging contacts. The charging contacts may be a metallic material and may be plated so as to appear gold or rose-gold in color, although other colors are also contemplated. The charging contacts may be arranged toward the second end 34 of the core frame structure 14, so that when the charging receptacle 38 is brought into contact with the charging unit 52, corresponding charging contacts of the charging unit 52 are aligned and in electrical communication with the corresponding charging contacts of the charging receptacle 38.

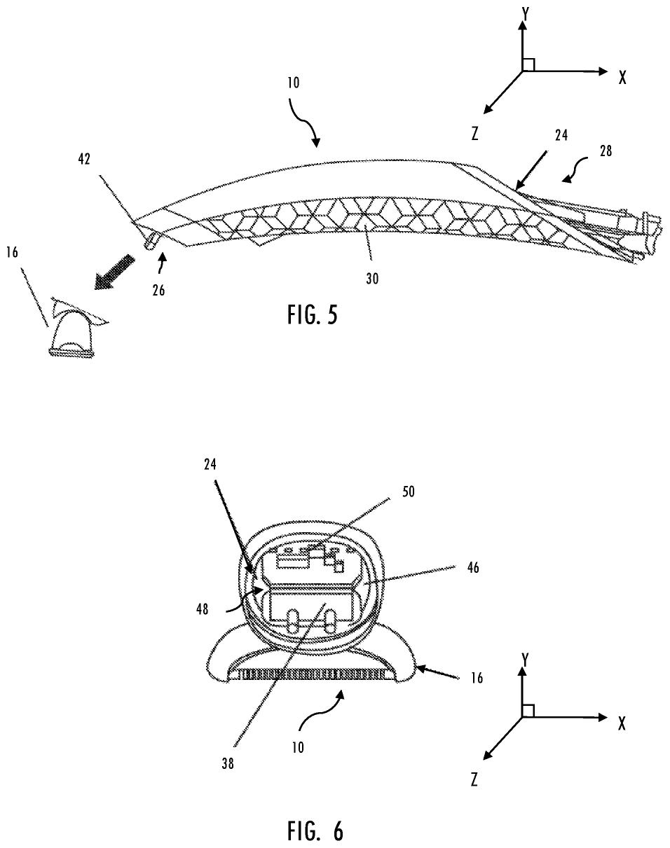

Referring back to FIG. 4, in some example embodiments the shell 12 is configured to receive the core frame structure 14 through the open rear end 24 of the shell 12 so that the core frame structure 14 is positioned in the internal cavity 28 of the shell 12 such that the transmission 36 is arranged near the open front end 26 of the shell 12. In particular, the first end 32 of the core frame structure 14 may be inserted through the open rear end 24 of the shell 12 and into the internal cavity 28 of the shell 12. With this insertion, the transmission arm 42 may extend through the open front end 26 of the shell 12 for coupling with the blade assembly 16, as illustrated in FIG. 5. Such insertion is done in a substantially linear motion manually or by machine, and is enabled due to the shape of the internal cavity 28 and the shape of the core frame structure 14. Generally, the core frame structure 14 has a shape that corresponds to a shape of the internal cavity 28 for ease of insertion during manufacture. For example, where the internal cavity 28 has a generally-linear shape (i.e., at least the middle portion 28a of the internal cavity 28 is linear along the X-axis, while the front portion 28b and the rear portion 28c are curved), the core frame structure 14 has a corresponding generally-linear shape, with at least a middle portion 14a of core frame structure 14 (including the motor 40 and transmission 36 forming a substantially sealed cavity with the shell) being linear along the X-axis, while a front portion 14b (including the transmission arm 42 forming a substantially sealed cavity) and a rear portion 14c (including the power source compartment 48 forming a sealed cavity around the power source 46 and the first circuit board 50) are curved downward in a Y-direction away from the X-axis. Thus, the open rear end 26 of the shell 12 may be angled away from or downward relative to the longitudinal axis A of the shell 12 extending along the length thereof, and the second end 34 of the core frame structure 14 may be correspondingly angled away from or downward relative to a longitudinal axis B of the core frame structure 14, which is co-axial with the longitudinal axis A, extending along a length of the core frame structure 14 defined along the X-axis.

The shell 12 and the core frame structure 14 may be secured to one another in any number of ways once the core frame structure 14 is inserted into the shell 12. For example, and as illustrated in FIGS. 9D and 9E, top and bottom locking notches 68, 70 defined in the first layer 20 may align with corresponding top and bottom catches 72, 74 arranged on a ramp 76 of the core frame structure 14, once the core frame structure 14 has been successfully inserted into the shell 12. The notches 68, 70 and the bottom catches 72, 74 on the ramp 76 may secure the core frame structure 14 to inside the shell 12. Further, a frame screw 78 may be inserted through the first layer 20 and into the core frame structure 14 through an opening in the first layer 20. Other methods of securing the core frame structure 14 to the shell 12 are also contemplated by this disclosure, and may include the addition of bonding or an adhesive applied to the core frame structure 14 so that it may adhere to the internal cavity 28 upon insertion of the core frame structure 14 into the shell 12.

Once the core frame structure 14 is inserted within the shell 12, and as illustrated in FIGS. 9F-9K, a rear cover 80 may be engageable with the open rear end 24 of the shell 12 so as to cover and form a seal over the open rear end 24 of the shell 12. The open rear end 24 of the shell 12 may be angled in such a way that a top of the open rear end 24 is farther away from a rear edge of the hair removal apparatus 10 than a bottom of the opening of the open rear end 24. The rear cover 80 may be formed so as to complement the open rear end 24 of the shell 12, e.g., have a corresponding angle. The rear cover 80 and a trim ring 82 may be received on an interior rim 84 formed on the first layer 20. The trim ring 82 may be a metallic-colored material (e.g., rose gold) so that it appears metallic in appearance. The trim ring 82 may be assembled on the interior rim 84 prior to the rear cover 80 being assembled over the open rear end 24 of the shell 12. While the rear cover 80 may be removable or fixed, the trim ring 82 may be secured in place using glue, ultrasonic welding, or by pressure applied to the rear cover 80. With the rear cover 80 and the trim ring 82 assembled and contacting the interior rim 84 and the second layer 22, a seal is created to prevent water and debris from entering internal cavity 28. The seal can also be formed by using a gasket or any other similar method of sealing the internal cavity 28 to make it waterproof.

To secure the rear cover 80 to the shell 12, the rear cover 80 may define an aperture 86. At least a portion of the charging receptacle 38 may extend out of the shell 12 and into the aperture 86 of the rear cover 80 when the rear cover 80 is engaged with the open rear end 24 of the shell 12. Upper ribs 88 and side ribs 90 may be defined on an internal surface 92 of the rear cover 80, and which respectively engage upper cavities or notches 94 and side cavities or notches 96 defined on the core frame structure 14. In some example embodiments, the rear cover 80 may be secured to the second end 34 of the core frame structure 14 via a screw 98 that is inserted through screw recesses 100 defined in the rear cover 80 and correspondingly in the arc 62 of the charging receptacle 38. Removal of the screw 98 may allow for removal of the rear cover 80 and access to the second end 34 of the core frame structure 14.

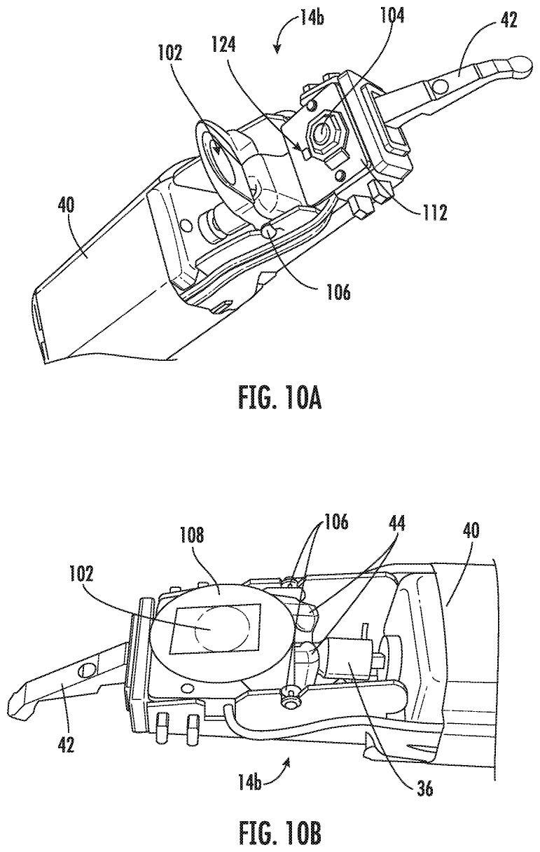

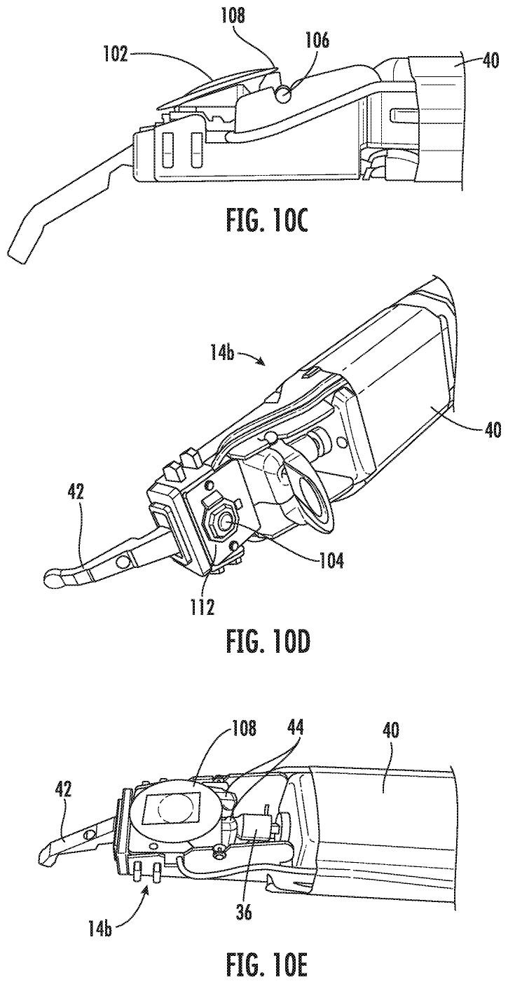

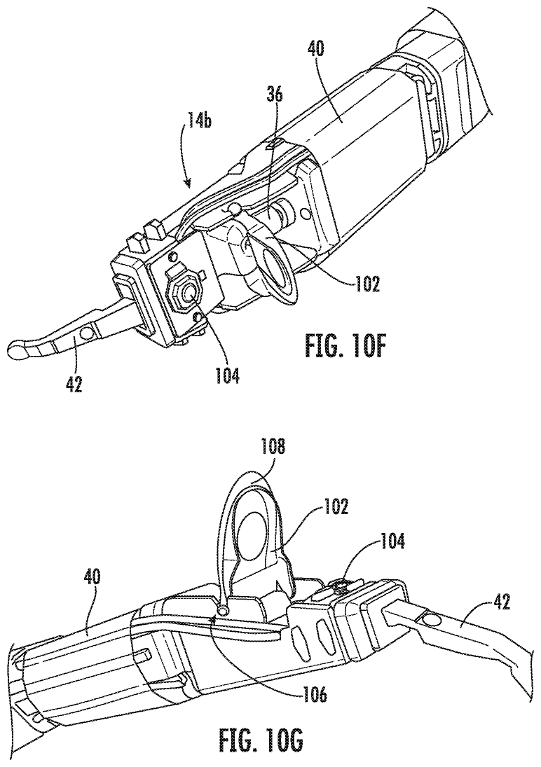

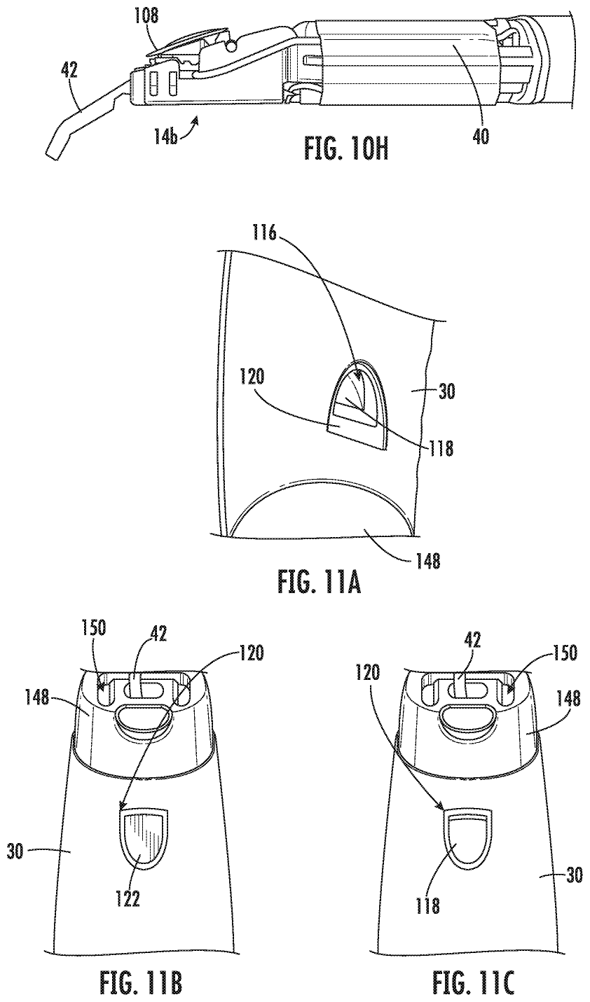

Referring now to FIGS. 10A-10H, detailed views of the first end 32 of the core-frame structure are illustrated. For example, as illustrated in FIG. 10A, the core frame structure 14 further comprises another element of an actuator 102 arranged toward the first end 32 of the core frame structure 14 in the front portion 14b. Force applied to the actuator 102 may alter an operating condition of the hair removal apparatus 10. An operating condition may be a mode that the hair removal apparatus 10, such as “ON” mode, “OFF” mode, etc. For example, in a first operating condition or an “ON” mode, a first instance of force application to the actuator 102 may cause electrical current to flow from the power source 46 to the motor 40 so as to actuate the motor 40. In this example, in a second operating condition or an “OFF” mode, a second instance of force application to the actuator 102 may cause the electrical current to cease to flow from the power source 46 to the motor 40 so as to deactuate the motor.

A power switch 104 may be coupled (e.g., mechanically or electrically-connected) to the actuator 102 for controlling the flow of the electrical current from the power source 46 to the motor 40 in response to the application of force to the actuator 102. For example, the actuator 102 may be hinged such that the application of force to the actuator 102 causes the actuator 102 to hingedly rotate about a hinged axis (e.g., an axis of a hinge 106) and depress the power switch 104 so as to control the flow of the electrical current from the power source 46 to the motor 40. A masking layer 108 comprising a substantially opaque or light blocking material may be positioned above the actuator 102. One or more openings in the masking layer 108 may permit light to pass through the masking layer. In one example embodiment, the light blocking material of the masking layer 108 is a light-blocking tape that extends over an opening defined in a first layer 20 of the shell 12, whereas in other example embodiments, the masking layer 108 is formed from a portion of the first layer 20 of the shell 12.

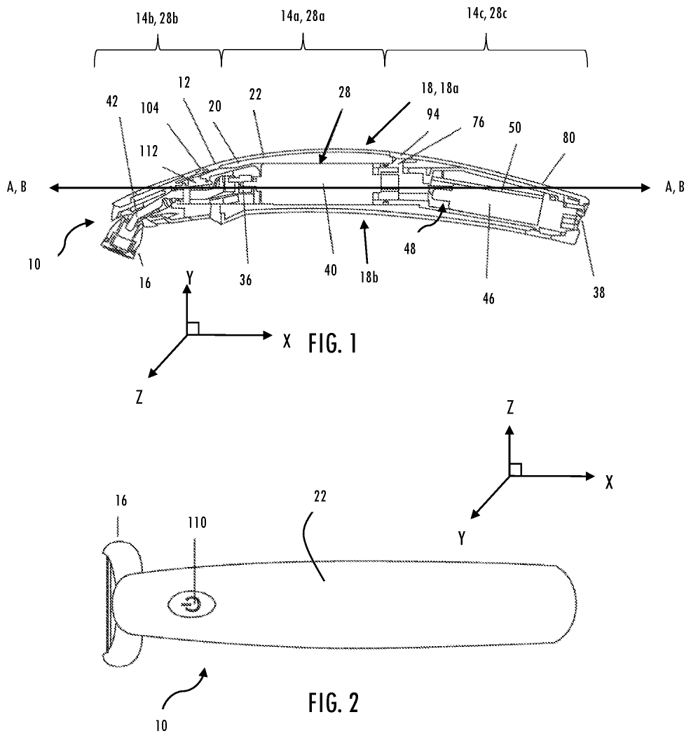

As illustrated in FIG. 2, a portion of the second layer 22 is aligned with the actuator 70 and defines a substantially translucent region 110. The substantially translucent region 110 may be formed so that the second layer 22 has a reduced wall thickness aligned with one or more openings in the first layer 20. The substantially translucent region 110 may be embossed, stamped, or otherwise formed so as to indicate the “power button” to a user, which corresponds to the location of the actuator 102. The actuator 102 may be aligned with the substantially translucent region 110, such that application of force to the substantially translucent region 110 of the second layer 22, will result in force applied to the actuator 102 and thereby the power switch 104. Advantageously, the arrangement of the power switch 104 under the substantially translucent region 110 seals the power switch 104 underneath the second layer 22, so that the power switch 104 and associated electrical components remain waterproof.

The power switch 104 may be a multi-functional touch switch that is mounted for multi-mode circuit control on a second circuit board 112 arranged toward the first end 32 of the core frame structure 14 in the front portion 14b. The second circuit board 112 may be in electrical connection with the first circuit board 50, and the first circuit board 50 and/or the second circuit board 112 may be in communication with the one or more of the power source 46, the motor 40, the charging receptacle 38, one or more peripheral elements, and the power switch 104.

In some example embodiments, the power switch 104 is formed from an opening in the first layer 20 and an extension having an arm with a circular end formed from a rigid material extends into the opening, while the second layer 22 covers the opening and the extension. In some other example embodiments, and as illustrated in FIGS. 10A-10H, the power switch 104 is a push button tact switch, such that the number of times that the power switch 104 is depressed corresponds to a different function or operating condition of the control circuit on the second circuit board 112. Each operating condition or function of the control circuit may correspond to a different output power of the motor 40. As such, the number of times that the power switch 104 is depressed may determine the output power of the motor 40 and the mode of the hair removal apparatus 10 (e.g., “OFF” in a second operating condition, “ON” in a second operating condition). However, the power switch 104 may be any other type of switch other than a multi-function push button tact switch, such as a rotary switch, a multi-position slide switch, a pressure-sensitive switch, a capacitive or inductive switch, etc.

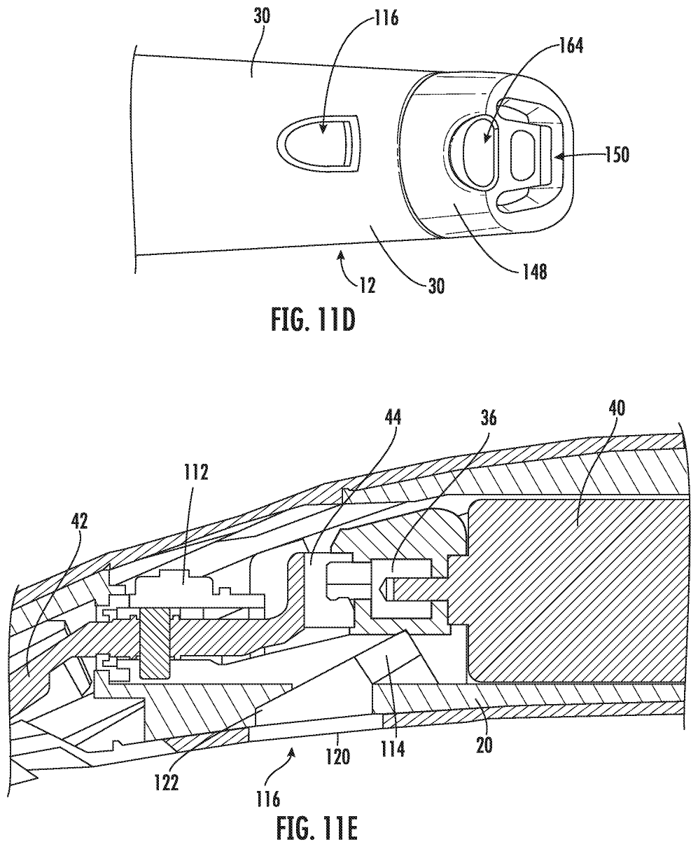

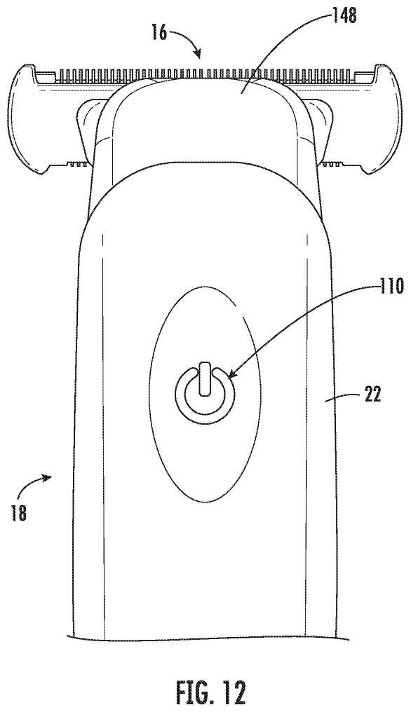

The power source 46 may be in electrical and/or mechanical communication with one or more peripheral elements such as, for example, light source(s) (e.g., light elements such as LEDs), indicator(s), sensor(s), timer(s), and the like. In some example embodiments, one of the peripheral elements is a first light source 114. As illustrated in FIGS. 11A-11E, the first light source 114 may be an LED arranged in the front portion 14b of the core frame structure 14 and electrically-connected with the power source 46 either directly or via the first circuit board 50. In response to the application of force applied to the actuator 102, the first light source 114 may provide illumination when the electrical current flows from the power source 46 to the first light source 114 in the first operating condition. An angled lighting cavity 116 may be formed between an angled surface 118 of the core frame structure 14 and the shell 12. The lighting cavity 116 may have a substantially transparent window 120 arranged on the outer surface of the shell 14 so as to direct the illumination along the angled surface 118 of the core frame structure 14 and through the substantially transparent window 120 toward the blade assembly 16, to thereby illuminate a surface of a user's body where the hair removal apparatus 10 is being used. A reflective treatment or coating 122 may be applied to the angled surface 118 of the core frame structure 14 to reflect the illumination from the angled surface 118 of the core frame structure 14 toward the blade assembly 16. The reflective coating 122 may be a piece of reflective silver tape, a high polished plastic material, hot stamping material of the angled surface 118, paint, electroplating of the angled surface 118, vacuum deposition on the angled surface 118, and/or another surface material capable of minimizing light absorption and reflecting light toward the substantially transparent window 120.

A second light source 124 may be mounted on the second circuit board 112 and electrically-connected with the power source 46 either directly or via the electrical circuit formed between the first circuit board 50 and the second circuit board 112. The second light source 124 may be arranged adjacent to or be integral with the power switch 104, wherein the portion of the shell 12 aligned with the actuator 102 defining the substantially translucent region 110 allows, in response to the application of force to the actuator 102, illumination from the second light source 124 to pass through opening(s) in the masking layer 108 to illuminate the substantially translucent region 110 from the internal cavity 28, where the illumination is visible through the outer surface of the shell 12 and provides an indication of the hair removal apparatus 10 being powered on (e.g., in an “ON” mode in the first operating condition), as illustrated in FIG. 12. More particularly, the portion of the shell 12 aligned with the actuator 102 includes a portion of the first layer 20 that defines an opening and the substantially translucent region 110 is a portion of the second layer 22 that is substantially translucent such that the illumination from the second light source 124 illuminates the translucent region 110 of the second layer 22 from the internal cavity 28 and through the opening in the first layer 20 so that the illumination is visible through the outer surface of the shell 12 and provides an indication of the hair removal apparatus 10 being powered on in the first operating condition. In this manner, a back-light configuration may be provided, which is sealed against the entry of debris, water, and other foreign materials.

In some example embodiments, the illumination of the second light source 124 (and/or the first light source 114) has a cycling sequence (e.g., is intermittent or flashing) during charging of the power source 46 through the charging receptacle 38, even if the hair removal apparatus 10 is in an “OFF” mode in the second operating condition. A similar or different type of cycling sequence for one or both of the second light source 124 and the first light source 114 is contemplated to indicate that the power source 46 of the hair removal apparatus 10 needs charging and/or is charging. Various other visual indicators, such as color change, rapid flashing, slow flashing, constantly on, off and combinations thereof can be used with the second light source 124 and/or the first light source 114 so as to indicate function, mode, low battery, use, and charging.

Referring now to the blade assembly 16, example blade assemblies are described in U.S. Provisional Appl. No. 62/936,999, filed Nov. 18, 2019 and entitled “Articulating Blade Assembly for Hair Removal Device,” and U.S. Appl. Pub. No. 2018/0326602 to Khubani, which applications are hereby incorporated by reference in their entirety herein.

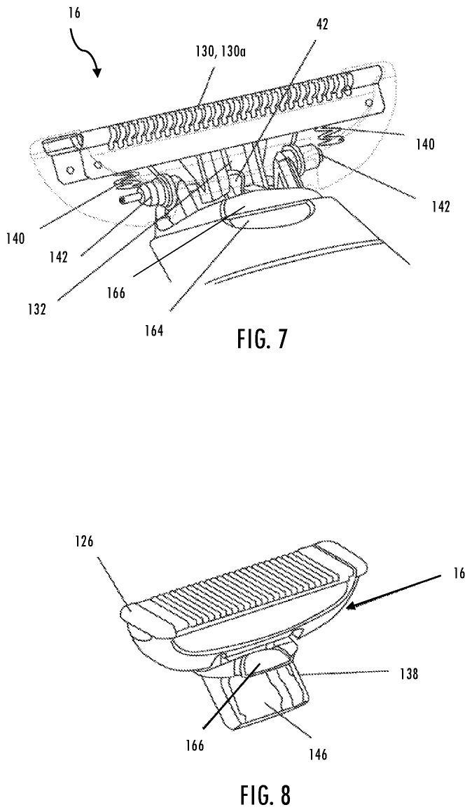

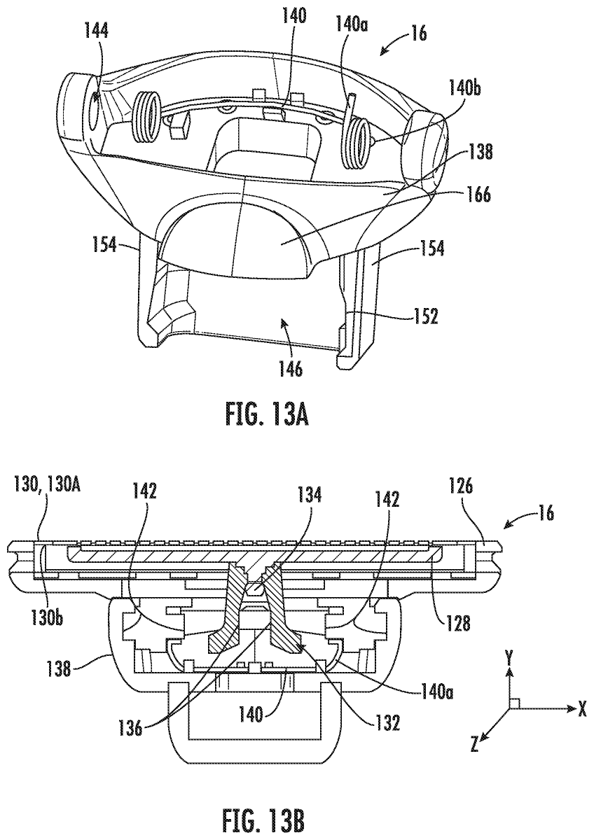

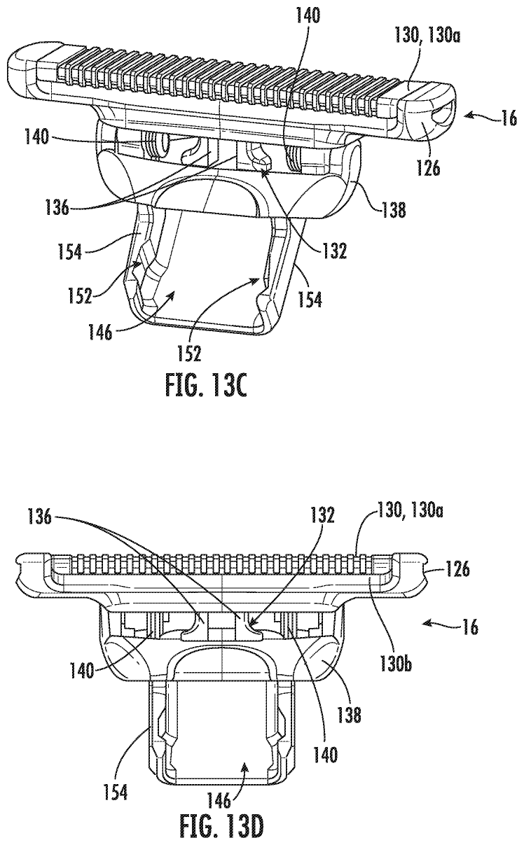

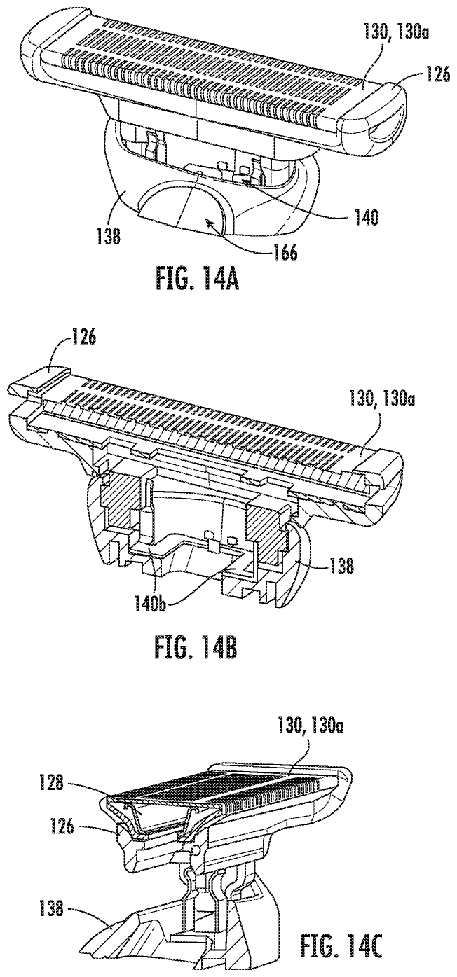

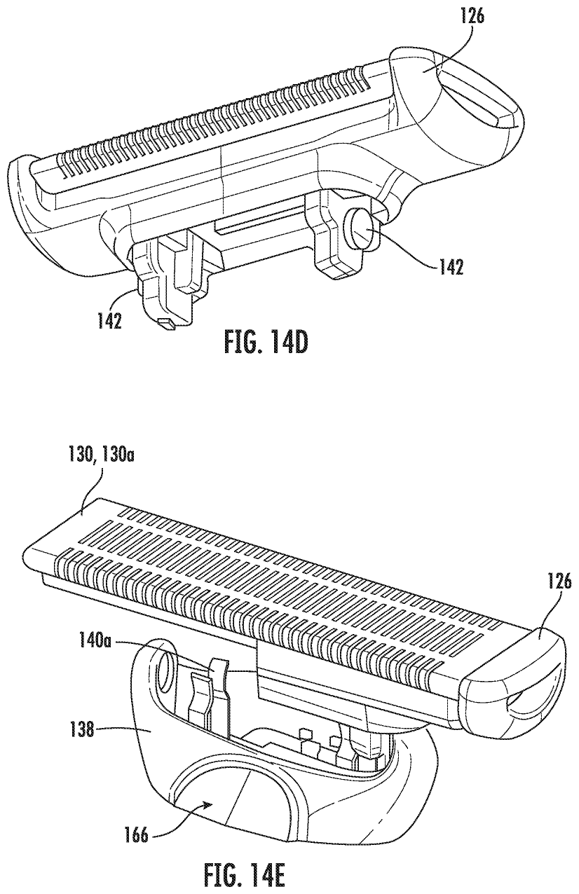

One example embodiment of the blade assembly 16 is shown, for example, in FIGS. 7 and 8, while FIGS. 13A-14E illustrate in greater detail example components of the blade assembly 16. Generally, the blade assembly 16 is engageable with the open front end 26 of the shell 12 and is enabled to bi-directionally travel or move in either of two opposing directions from an initial or equilibrium position relative to the handle 18 before returning to the initial or equilibrium position. The blade assembly 16 may comprise a blade housing 126 arranged to retain a moving blade 128 and a stationary blade 130. The moving blade 128 and/or the stationary blade 130 may be a metallic material and may be plated with another material. For example, the moving blade 128 and/or the stationary blade 130 may be 18 Karat gold plated, although other materials are contemplated as well. The stationary blade 130 may remain stationary while the moving blade 128 reciprocates in response to actuation of the motor 40. The stationary blade 130 may be molded (e.g., insert molded or otherwise coupled) with the blade housing 126 so that a top surface 130a of the stationary blade 130 contacts a user's skin while the hair removal apparatus 10 is in use. The moving blade 128 may be arranged on an opposing bottom surface 130b of the stationary blade 130 to laterally reciprocate relative to the stationary blade 130 when in the hair removal apparatus 10 is in use.

The blade assembly 16 may also comprise a transmission arm receiver 132 coupled to a protrusion 134 extending either directly from the moving blade 128 or from a moving blade housing in which the moving blade 128 is attached. As illustrated in FIGS. 7 and 13B, the transmission arm receiver 132 is coupled directly to the protrusion 134 extending from the moving blade 128. The transmission arm receiver 132 may define substantially parallel side walls 136 for receiving the transmission arm 42 therein. As used herein, “substantially parallel side walls” refers to at least a portion of the side walls 136 being parallel to one another. FIG. 7 shows the transmission arm 42 being received within or between the parallel portion of the side walls 136 of the transmission arm receiver 132. As the motor 40 and thereby the transmission 36 experiences rotary movement in response to actuation of the motor 40, the transmission arm 42 may laterally reciprocate against the parallel side walls 136 of the transmission arm receiver 132 so as to cause lateral reciprocation and a cutting or shaving motion of the moving blade 128 in the X-direction.

A connector frame 138 may be hingedly coupled to the blade housing 126 so that the blade housing 126 is hingedly moveable relative thereto. More particularly, the blade housing 126 may rotate about an axis of rotation defined by the hinged coupling from an initial or equilibrium position, during application of a force on the blade housing 126. For example, the blade assembly 16 is able to hingedly move from the initial position (FIG. 1) towards a top surface 18a of the handle 18 and from the initial position towards a bottom surface 18b of the handle 18. In another example, the blade assembly is able to hingedly travel from the initial position (FIG. 1) starting from the bottom surface 18b of the handle 18 towards the top surface 18a of the handle 18.

The blade housing 126 may be configured so that no restoring force is present in the initial or equilibrium position, whereas a biasing element 140, such as one, two, three, four, etc., springs, may interact with the blade housing 126 and/or the connector frame 138 to provide a restoring force to the blade housing 126 when application of the force to the blade housing 126 causes the blade housing 126 to rotate out of the initial or equilibrium position. In some example embodiments, a pivot structure on the blade housing 126 may interact with a corresponding pivot structure on the connector frame 138. More particularly, and as illustrated in FIGS. 13A-13D and 14A-14E, protrusions 142 facing outwardly on the blade housing 126 may be inserted within corresponding depressions 144 of the connector frame 138. The biasing element 140 may be two springs with first ends 140a that are biased against a portion of the blade housing 126 and second ends 140b that are biased against a portion of the connector frame 138. The springs of the biasing element 140 may thereby provide the restoring force to the blade housing 126 to hingedly rotate the blade housing 126 into the initial position. This hinged rotation allows the blade assembly to easily and efficiently glide over a user's skin and along the contours of the user's body, without having to change the angle at which the hair removal apparatus 10 contacts the user's body.

Where the biasing elements 140 are springs, the springs may be, for example, C-shaped, I-shaped, H-shaped, M-shaped, T-shaped, U-shaped, X-shaped, W-shaped or triangular shaped springs that each apply force. Such springs may be compression, extension, torsion, linear, variable rate, or constant force springs, using a variety of configurations such as coil springs, leaf springs, flat springs, machined springs, molded springs, or any combinations of the above. Other arrangements of springs may be used to form other geometric shapes that provide a restoring force.

The connector frame 138 may define a channel 146 aligned with the transmission arm receiver 132 and arranged to receive the transmission arm 42 therethrough, when the channel 146 is inserted into the open front end 26 of the shell 12 so as to engage the blade assembly 16 with the shell 12. Upon engagement of the blade assembly 16 with the open front end 26 of the shell 12 (and insertion of the core frame structure 14 within the shell 12), the transmission arm 42 may extend through the open front end 26 of the shell 12 and through the channel 146 of the connector frame 138. In use, the transmission arm 42 may laterally reciprocate against the parallel side walls 136 of the transmission arm receiver 132 to cause lateral reciprocation of the moving blade 128 in the X-direction in response to actuation of the motor 40. Therefore, when force is applied to the actuator 102, the electrical current is caused to flow from the power source 46 to the motor 40, so as to actuate the motor 40 and cause the moving blade 128 to laterally reciprocate relative to the length of the shell 12 when the blade assembly 16 is engaged with the open front end 26 of the shell 12.

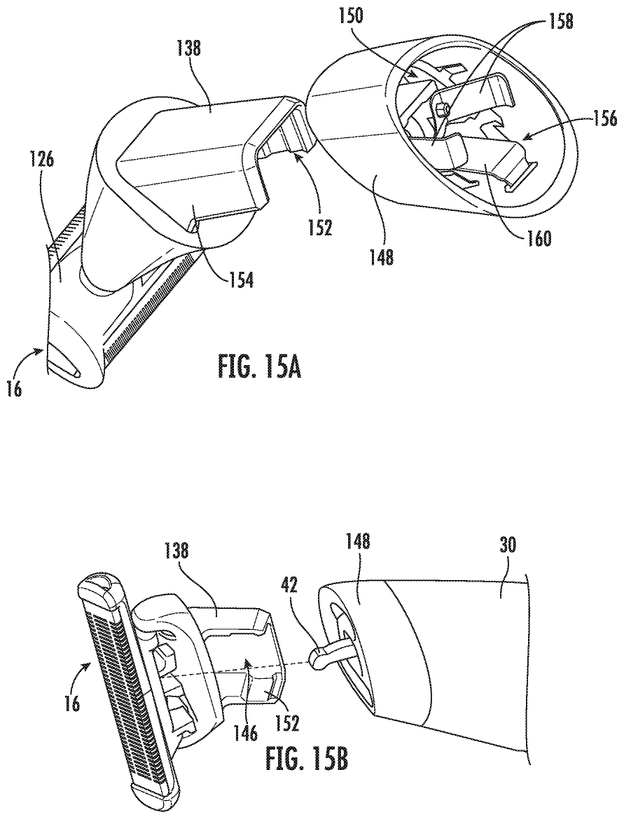

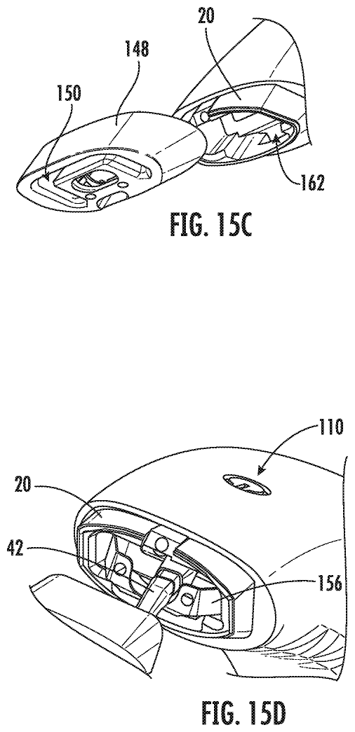

To releaseably secure or engage the blade assembly 16 with the open front end 26 of the shell 12, the connector frame 138 may engage a front ring 148, as illustrated in FIGS. 15A-15D. The front ring 148 may have a receiving opening 150 that engages the first layer 20 of the shell 12. The front ring 148, similar to the trim ring 82, may be rose gold in appearance and may cooperate with the second layer 22 to provide for a substantially waterproof seal at the open front end 26 of the shell 12. In particular, once the front ring 148 is engaged with the open front end 26 of the shell 12, the channel 146 may be inserted into the receiving opening 150 of the front ring 148. Notches 152 defined on opposing side walls 154 of the channel 146 (FIGS. 8, 13A, 13C, 13D) may be received by a resilient prong structure 156 (FIG. 15A) arranged about the open front end 26 of the shell 12. One example embodiment of the resilient prong structure 156 is illustrated in FIG. 15A, where the resilient prong structure 156 is in the form of spring clip side arms 158 formed on an inner side surface of the front ring 148 and a spring clip bottom arm 160 formed on the inner bottom surface of the front ring 148. Once the channel 146 is inserted into the receiving opening 150, the notches 152 of the channel 146 are engaged with and retained by the spring clip side arms 158, which then apply an outward pressure on the opposing side walls 154 of the channel 146. The spring clip bottom arm 160 is arranged to contact a corresponding open front end notch 162 defined on the open front end 26 of the shell 12 (FIG. 15C) and secure the front ring 148 to the open front end 26 of the shell 12. Alternatively, the blade assembly 16 may be pivotally attached, rotationally attached, magnetically attached, and/or any other attachment method to the shell 12 or transmission arm 42, or may be fixedly attached thereto.

To remove the blade assembly 16 from the open front end 26 of the shell 12, the outer surface of the shell 12 may comprise an ejection structure that in use, disengages the blade assembly 16 from the open front end 26 of the shell 12 to allow for cleaning of the blade assembly 16 and/or replacement thereof. The ejection structure may be a push button, a slide, or another mechanical arrangement. For example, and as illustrated in FIG. 7, the ejection structure may comprise a notch 164 defined on the outer surface of the shell 12 that corresponds to a similar notch 166 on the connector frame 138. Forced applied to the notch 164 on the outer surface of the shell 12, results in pushing the notches 152 of the channel 146 of engagement with the resilient prong structure, and thereby the connector frame 138 out of engagement with the receiving opening 150.

In some example embodiments, the hair removal apparatus 10 may be packaged together as a kit. For example, the kit may comprise packaging, where the packaging comprises at least a handle 18 comprising a curved shell 12 and a core frame structure 14 inserted into the curved shell 12 as described herein, a blade assembly 16 as described herein that is configured to engage the handle 18, and a charging unit 52 configured to engage the handle 18. More particularly, the charging unit 52 is arrangeable to engage the power source 46 housed in the power source compartment 48 and deliver an electrical charge thereto.

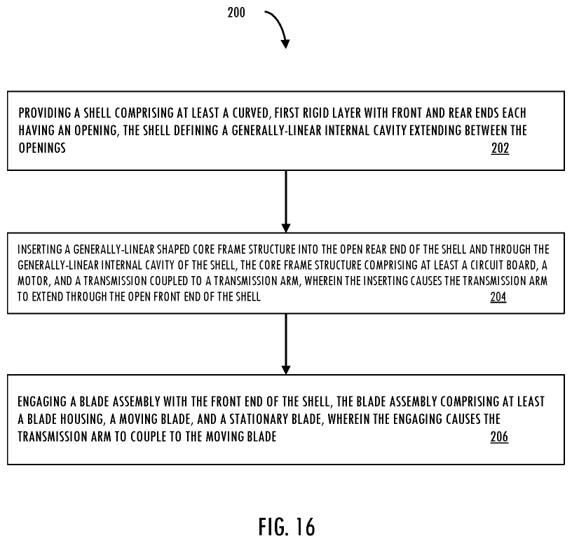

Turning now to FIG. 16, a method flow diagram illustrating the method, generally designated 200, for assembling a hair removal apparatus is illustrated. The hair removal apparatus may be a hair removal apparatus similar to that described herein with regard to FIGS. 1-15D. In a first method step 202, a shell comprising at least a curved, first rigid layer with front and rear ends each having an opening is provided, the shell defining a generally-linear internal cavity extending between the openings. In a second method step 204, a generally-linear shaped core frame structure is inserted into the open rear end of the shell and through the generally-linear internal cavity of the shell, the core frame structure comprising at least a circuit board, a motor, and a transmission coupled to a transmission arm, wherein the inserting causes the transmission arm to extend through the open front end of the shell. In a third method step 206, a blade assembly is engaged with the front end of the shell, the blade assembly comprising at least a blade housing, a moving blade, and a stationary blade, wherein the engaging causes the transmission arm to couple to the moving blade.

Many modifications and other embodiments of the disclosure will come to mind to one skilled in the art to which this disclosure pertains having the benefit of the teachings presented in the foregoing descriptions and associate drawings. Therefore, it is to be understood that the disclosure is not to be limited to the specific embodiments disclosed herein and that modifications and other embodiments are intended to be included within the scope of the appended claims. Although specific terms are employed herein, they are used in a generic and descriptive sense only and not for purposes of limitation.

1. A hair removal apparatus comprising:
a curved shell having an outer surface and defining an internal cavity extending along a length of the curved shell from an open rear end to an open front end of the shell;
a core frame structure defining a first end and an opposing second end, and comprising:
a transmission arranged toward the first end of the core frame structure,
a charging receptacle arranged toward the second end of the core frame structure, and
a motor arranged between the transmission and the charging receptacle and coupled to the transmission,
wherein the shell is configured to receive the core frame structure through the open rear end thereof so that the core frame structure is positioned in the internal cavity of the shell such that the transmission is arranged near the open front end of the shell; and
a blade assembly engageable with the open front end of the shell and comprising a moving blade, the transmission being coupled to the moving blade so that upon actuation of the motor, the moving blade reciprocates.

2. The apparatus of claim 1, wherein the core frame structure further comprises a power source arranged between the motor and the charging receptacle, the power source being electrically-connected to the motor and the charging receptacle.

3. The apparatus of claim 2, wherein the core frame structure further comprises an actuator arranged toward the first end of the core frame structure, wherein force applied to the actuator alters an operating condition of the hair removal apparatus and causes electrical current to flow from the power source to the motor so as to actuate the motor and cause the moving blade to reciprocate in a first operating condition, and causes the electrical current to cease to flow in a second operating condition.

4. The apparatus of claim 3, further comprising a first light source electrically-connected with the power source, wherein in response to the application of force applied to the actuator, the first light source provides illumination when the electrical current flows from the power source to the first light source in the first operating condition.

5. The apparatus of claim 4, further comprising an angled lighting cavity formed between an angled surface of the core frame structure and the shell, the lighting cavity having a substantially transparent window arranged on the outer surface of the shell so as to direct the illumination along the angled surface of the core frame structure and through the substantially transparent window toward the blade assembly.

6. The apparatus of claim 5, wherein a reflective coating is applied to the angled surface of the core frame structure to reflect the illumination from the angled surface of the core frame structure toward the blade assembly.

7. The apparatus of claim 3, wherein the core frame structure further comprises a power switch coupled to the actuator, the power switch controlling the flow of the electrical current from the power source to the motor in response to the application of force to the actuator.

8. The apparatus of claim 7, wherein the actuator is hinged such that the application of force to the actuator causes the actuator to hingedly rotate about a hinged axis and depress the power switch so as to control the flow of the electrical current from the power source to the motor.

9. The apparatus of claim 7, further comprising a second light source electrically-connected with the power source, wherein a portion of the shell aligned with the actuator defines a substantially translucent region that allows, in response to the application of force to the actuator, illumination from the second light source to illuminate the translucent region from the internal cavity so that the illumination is visible through the outer surface of the shell and provides an indication of the hair removal apparatus being powered on in the first operating condition.

10. The apparatus of claim 9, wherein the illumination of the second light source is intermittent during charging of the power source through the charging receptacle.

11. The apparatus of claim 9, wherein the portion of the shell aligned with the actuator includes a portion of the first layer that defines an opening, and wherein the substantially translucent region is a portion of the second layer that is substantially translucent such that the illumination from the second light source illuminates the translucent region of the second layer from the internal cavity and through the opening in the first layer so that the illumination is visible through the outer surface of the shell and provides an indication of the hair removal apparatus being powered on.

12. The apparatus of claim 1, wherein the curved shell comprises at least a first rigid layer formed as a one-piece construction.

13. The apparatus of claim 12, wherein the curved shell comprises at least a second resilient layer and the second resilient layer is attached to the first rigid layer formed as the one-piece construction so as to provide the curved outer shell with a substantially continuous outer surface.

14. The apparatus of claim 1, wherein the open rear end of the shell is angled away from a longitudinal axis of the shell extending along the length thereof and the second end of the core frame structure is correspondingly angled away from a longitudinal axis of the core frame structure extending along a length thereof.

15. The apparatus of claim 1, further comprising a rear cover engageable with the open rear end of the shell so as to cover and form a seal over the open rear end of the shell, wherein the rear cover defines an aperture, at least a portion of the charging receptacle extending out of the shell and into the aperture of the rear cover when the rear cover is engaged with the open rear end of the shell.

16. The apparatus of claim 1, further comprising a transmission arm comprising a mechanical coupling for mechanically coupling the transmission arm with the transmission, wherein the transmission arm extends through the open front end of the shell for coupling with the blade assembly, and wherein the mechanical coupling between the transmission and the transmission arm causes the transmission arm to laterally reciprocate in response to actuation of the motor and thereby causes lateral reciprocation of the moving blade relative to the length of the shell when the blade assembly is engaged with the open front end of the shell.

17. The apparatus of claim 16, wherein the blade assembly further comprises:
a blade housing arranged to retain the moving blade;
a transmission arm receiver coupled to the moving blade and defining parallel side walls for receiving the transmission arm therein; and
a connector frame hingedly coupled to the blade housing so that the blade housing is hingedly moveable relative thereto, the connector frame defining a channel aligned with the transmission arm receiver and arranged to receive the transmission arm therethrough when the channel is inserted into the open front end of the shell to engage the blade assembly with the shell,
wherein, upon engagement of the blade assembly with the open front end of the shell, the transmission arm extends through the channel of the connector frame and laterally reciprocates against the parallel side walls of the transmission arm receiver to cause lateral reciprocation of the moving blade in response to actuation of the motor.

18. The apparatus of claim 16, wherein the channel defines notches on opposing parallel sides of the channel, the notches of the sides of the channel being received by a resilient prong structure arranged about the open front end of the shell so as to engage the blade assembly with the shell.

19. The apparatus of claim 1, wherein the outer surface of the shell comprises an ejection structure for disengaging the blade assembly from the open front end of the shell.

20. The apparatus of claim 1, wherein the internal cavity comprises a middle portion between the first end and the second end, the middle portion comprising parallel upper and lower surfaces.

21. A hair removal assembly comprising:
a shell comprising at least a first rigid layer coupled to a second resilient layer being attached to one another to form a handle, and comprising front and rear ends each having an opening, and a generally-linear internal cavity extending between the openings in the front and rear ends, the handle having a curvature forming a grip, the curvature extending between the front and rear ends;
a core frame structure comprising a power source compartment with a first circuit board, the first circuit board is in electrical connection with a motor, the motor is coupled to a transmission and the transmission is coupled to a transmission arm, the core frame structure has a corresponding generally-linear shape designed to fit within the generally linear internal cavity of the shell by inserting the core frame structure into the open rear end of the shell so that the transmission arm extends through the open front end of the shell, the second resilient layer is designed to create a waterproof tight seal to protect the core frame structure; and
a blade assembly comprising a blade housing, a moving blade and a stationary blade, the transmission arm is designed to engage the moving blade.

22. A method for assembling a hair removal apparatus, the method comprising:
providing a shell comprising at least a curved, first rigid layer with front and rear ends each having an opening, the shell defining a generally-linear internal cavity extending between the openings;
inserting a generally-linear shaped core frame structure into the open rear end of the shell and through the generally-linear internal cavity of the shell, the core frame structure comprising at least a circuit board, a motor, and a transmission coupled to a transmission arm, wherein the inserting causes the transmission arm to extend through the open front end of the shell; and
engaging a blade assembly with the front end of the shell, the blade assembly comprising at least a blade housing, a moving blade, and a stationary blade, wherein the engaging causes the transmission arm to couple to the moving blade.

23. The method of claim 22, further comprising attaching a second resilient layer of the shell to the curved first rigid layer to form a handle, the handle having a curvature forming a grip.
